(19) United States
(12) Patent Application Publication
(10) Pub. No.: US 2015/0001863 A1
(43) Pub. Date: Jan. 1, 2015

(54) LOWER STIFFENER FOR VEHICLE AND MANUFACTURING METHOD THEREOF

(71) Applicants: Hyundai Motor Company, Seoul (KR); Hanwha Advanced Materials Corporation, Seoul (KR)

(72) Inventors: Dong Eun CHA, Whasung-si (KR); Phil Jung JEONG, Whasung-Si (KR); Hyun Gyung KIM, Whasung-Si (KR); Seung Mok LEE, Whasung-Si (KR); Jong Myung LIM, Whasung-Si (KR)

(73) Assignees: Hanwha Advanced Materials Corporation, Seoul (KR); Hyundai Motor Company, Seoul (KR)

(21) Appl. No.: 14/019,881

(22) Filed: Sep. 6, 2013

(30) Foreign Application Priority Data
Jun. 26, 2013 (KR) 10-2013-0073439

(51) Int. Cl. B60R 19/03; B29C 45/16; B29C 53/14

(52) U.S. Cl. CPC B60R 19/03; B29C 53/14; B29C 45/16
USPC 293/120; 264/241

(57) ABSTRACT

A lower stiffener for a vehicle is provided. The lower stiffener includes a core cover longitudinally installed at a lower portion of a bumper, and an inner core longitudinally installed inside the core cover, wherein density and strength of the inner core are larger than those of the core cover.

### CROSS-REFERENCE TO RELATED APPLICATION

The present application claims priority of Korean Patent Application Number 10-2013-0073439 filed Jun. 26, 2013, the entire contents of which application is incorporated herein for all purposes by this reference.

### BACKGROUND OF INVENTION

1. Field of Invention

The present invention relates, in general, to a lower stiffener for vehicles and a manufacturing method thereof.

2. Description of Related Art

Recently, the trend in vehicles has been towards strengthening safety design features for drivers as well as pedestrians, so a variety of safety devices for pedestrians have been appearing, taking into account the safety of pedestrians in the case of collision accidents.

The safety devices include airbags, curved bumpers, and lower stiffeners which are installed at a lower side of a bumper.

Particularly, the lower stiffeners are safety devices for a pedestrian that, when a vehicle collides with a pedestrian, absorbs a portion of collision shock so as to lessen force transmitted to the pedestrian's knees. The lower stiffener has a bar feature which extends as long as the bumper, and a pair of mounts which are provided on both sides of the bar feature and are fixed to a vehicle body.

However, a conventional lower stiffener is made of steel so that upon collision, the lower stiffener could not exert proper elasticity and could not absorb collision force effectively. Further, in addition to the steel bar feature, a mount for the bar is also made of steel, increasing weight of a product. Moreover, due to the nature of steel, the degree of freedom in the formation of the lower stiffener is also reduced.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, the present invention has been made keeping in mind the above problems occurring in the related art, and the present invention is intended to propose a lower stiffener for a vehicle which is integrally composed of a bar member made of a plastic composite material instead of steel or aluminum, and a mount for fixing the bar member to a vehicle body, and a manufacturing method thereof.

Various aspects of the present invention provide for a lower stiffener for a vehicle including: a core cover longitudinally installed at a lower portion of a bumper; and an inner core longitudinally installed inside the core cover, wherein density and strength of the inner core are larger than those of the core cover.

A mount may be integrally provided at the core cover so as to connect the core cover to a vehicle frame.

The core cover and the inner core may be integrally formed with a plastic composite material.

The inner core may be twisted across the entire length thereof, and the core cover may surround the inner core.

A reinforcing rib may further be provided so as to connect the core cover and the mount

The plastic composite material may be a continuous fiber reinforced thermoplastic plastic.

The mount and the reinforcing rib may be formed of a glass fiber reinforced composite material.

According to another aspect of the present invention, a method of manufacturing a lower stiffener for a vehicle, includes: forming a twisted inner core using a first plastic composite material; and integrally forming a core cover over the inner core by placing a second plastic composite material around the inner core, and pressurizing the second plastic composite material.

The inner core may be formed by twisting a plurality of first-plastic bars each being made of the first plastic composite material.

The core cover may be formed by stacking a plurality of second-plastic bars, each being made of the second plastic composite material, around the inner core and pressurizing the stacked second-plastic bars.

The method may further include preheating the first and second plastic bars to a predefined temperature prior to the formation of the inner core.

The first and second plastic bars may be formed prior to the preheating stage by impregnating a plurality of stretched fiber strands with fused plastic resin and injection-molding the former material into bars using a molding machine.

According to the lower stiffener for vehicles having the above-mentioned configuration and the manufacturing method thereof, the lower stiffener made of a plastic composite material has improved elasticity along with improved strength, effectively absorbing collision shock upon collision with a pedestrian.

Further, the use of the plastic material contributes to a reduction in weight, compared to an existing steel-type product, an adjustment in a shock absorption rate by means of adjustment of composition ratio between plastic and other material, and an increase in degree of freedom in shaping of parts compared to a steel-type product, which increases availability of diversified designs for a bumper.

Furthermore, the mount is formed on the bar member not separately but integrally, thereby avoiding additional cost expenditure for the provision of the mount, and allowing easy shaping of the mount.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the configuration of an exemplary lower stiffener for vehicles according to the present invention;

FIG. 2 is a view showing an exemplary reinforcing rib in the lower stiffener for vehicles;

FIG. 3 is a flow diagram showing a procedure of an exemplary method of manufacturing the lower stiffener for vehicles according to the present invention;

FIG. 4 is a view showing a stage of forming a plastic bar in the exemplary manufacturing method;

FIG. 5 is a view showing an exemplary rod-type lower stiffener for vehicles according to the present invention; and

FIG. 6 is a view showing an exemplary plate-type lower stiffener for vehicles according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

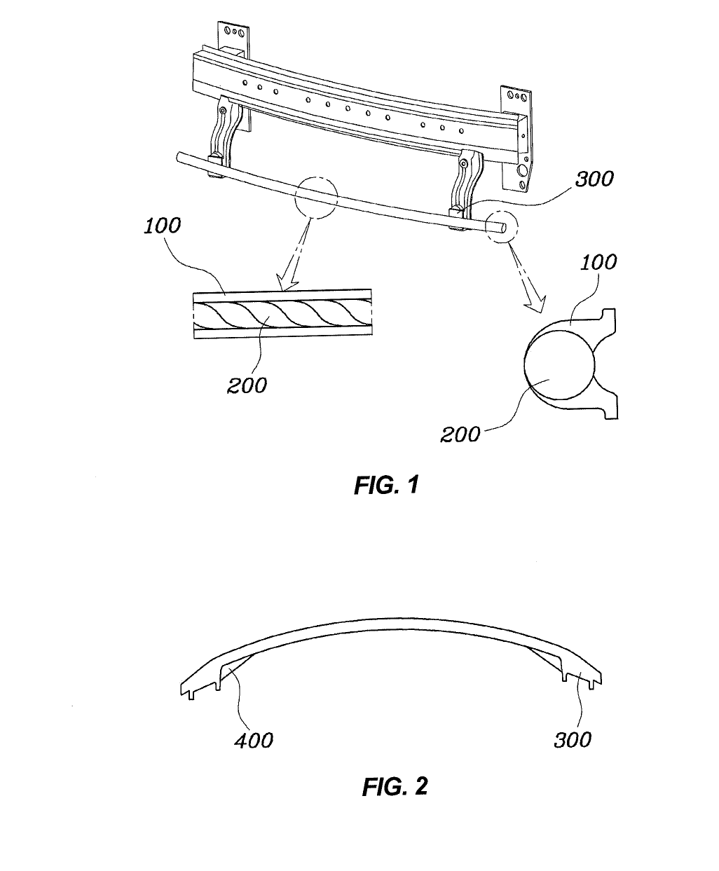

FIG. 1 is a view showing the configuration of a lower stiffener for vehicles according to various embodiments of the present invention. The lower stiffener includes: a core cover 100 which is longitudinally installed at a lower portion of a bumper; and an inner core 200 which is longitudinally installed inside the core cover 100, wherein density and strength of the inner core are larger than those of the core cover 100.

Specifically, the inner core 200 is twisted across the entire length thereof, and the core cover 100 surrounds the inner core 200. The twisted form of the inner core 200 enables the inner core to have more improved tensile strength and therefore improved strength of its entirety, so the ability to absorb collision shocks also increases. On the contrary, the core cover 100 surrounds the inner core 200 in an untwisted form, so the core cover has lower strength, but higher flexibility than the inner core 200. This heterogeneously-shaped lamination structure between the inner core 200 and the core cover 100 can improve both the strength and flexibility.

Although the inner core 200 and the core cover 100 are formed in different shapes with the same material, the inner core and the core cover may be formed, with different materials into a variety of shapes beside a twist. These additional shapes are also capable of reinforcing the core structure.

Further, on both sides of the core cover, a mount 300 is integrally provided on the core cover 100 so as to connect the core cover 100 to a vehicle frame. One will appreciate that such integral components may be monolithically formed. Since the mount 300 is integrally formed when the core cover 100 is formed, the core cover 100 can be attached to a vehicle body without using a separate mount. Since there is no need to provide a separate mount, the manufacturing process is simplified and the manufacturing cost is also reduced.

A reinforcing rib 400 may further be provided so as to connect the core cover 100 and the mount 300. Such a reinforcing rib 400 is shown in FIG. 2. The reinforcing ribs 400 are provided on both sides of the core cover adjacent the mounts, so that they serve to, upon a collision event, prevent stress concentration at a connection point between the mount 300 and the core cover 100. Further, the reinforcing rib provides effects of enlarging a contact area between the mount 300 and the core cover 100, enabling absorption of more shock energy than in the case of only the mount 300 being provided. Further, since absorption of shock energy can vary depending upon the length and shape of the reinforcing rib 400, the deformation of the lower stiffener can be regulated within a certain range by changing only the design of the reinforcing rib 400 without separate reinforcing design of the core cover 100 and the inner core 200.

The core cover 100 and the inner core 200 may be integrally formed with a plastic composite material. One will appreciate that such integral components may be monolithically formed. Here, the plastic composite material may be a continuous fiber-reinforced thermoplastic (CFT) plastic, in which glass fiber is added to polypropylene (PP), so that the material has strong tensile strength induced from the glass fiber and elasticity induced from polypropylene. Thus, upon collision, the plastic material can effectively absorb collision shocks applied to the inner core 200 and the core cover 100.

Thus, the composite material has advantages of both glass fiber and plastic, so, as compared to steel, the composite material provides effects of reduced weight, easier shaping, higher shock absorption and the like. This enables the integral formation of diversified shaped mount on the core cover 100, or the provision of the reinforcing rib 400 being able to have a variety of shapes.

Although the CFT plastic in which glass fiber is added to PP has been illustrated, the composite material may comprise other material in which, for example, continuous fiber, such as glass fiber, carbon fiber, aramid fiber, or the like, is added to thermoplastic resin, such as polyamide, polyacetal, polyethylene, or the like, or thermosetting resin, such as epoxy or the like.

Further, the mount 300 and the reinforcing rib 400 may be formed of a glass fiber reinforced composite material.

Specifically, the glass fiber reinforced composite material such as Glass fiber Mat reinforced Thermoplastics (GMT) is a material in which glass fiber is added to polypropylene. The GMT material has physical properties that have similar strength to iron but is 70% the weight. Further, while the CFT material is composed of long fibers, the GMT material is composed of short fibers so that it is applicable to small-size parts. Thus, the GMT material can be properly adapted to the mount 300 or the reinforcing rib 400.

Further, the GMT material has advantages that it is resistant to corrosion, can be recycled, and can absorb sound, contributing to a reduction in total weight of the lower stiffener, and to the elimination of sound that is possibly generated at the vehicle body and the mount

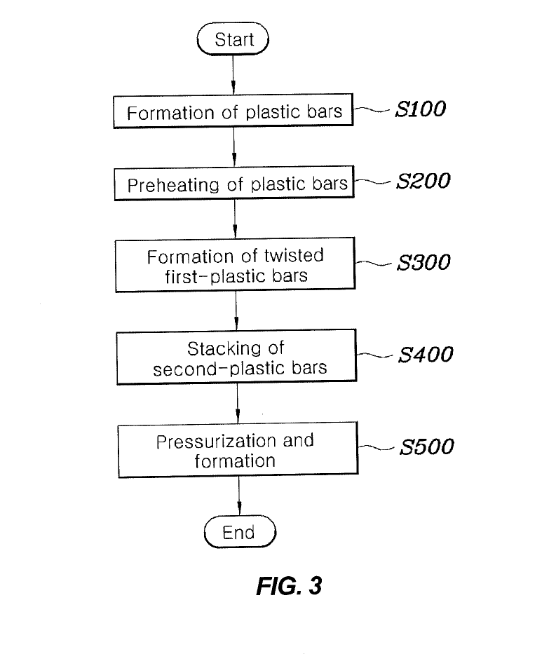

FIG. 3 is a flow diagram showing a procedure of a method of manufacturing the lower stiffener for vehicles according to various embodiments of the present invention.

The method includes: forming a twisted inner core 200 using a first plastic composite material (S300); and integrally forming a core cover 100 over the inner core 200 by placing a second plastic composite material around the inner core (S400), and pressurizing the second plastic composite material (S500).

Specifically, the inner core 200 is formed by twisting the plurality of the first plastic bars made of the first plastic composite material. Here, the first plastic composite material may be the CFT material that was described before.

Further, the core cover 100 may be formed by stacking the plurality of the second plastic bars made of the second plastic composite material around the inner core 200, and pressurizing the stacked plastic bars. Here, the second plastic composite material may be the same CFT material as the first plastic composite material.

That is, the first and second plastic bars are formed using the same material, so that the first and second plastic bars can be formed in a single process, reducing the number of processing stages. Further, since the inner core 200 has improved strength compared to the core cover 100 only with twisting of the first plastic bars, there is no problem in designing the core structure with respect to reinforcement, even though the first and second plastic bars are formed using the same material.

However, it is also natural that the first and second plastic bars are formed with different materials.

A general procedure of manufacturing the lower stiffener for a vehicle will now be described.

First, a stage S100 is carried out such that a plurality of stretched fiber strands is impregnated with fused plastic resin and the resultant material is injection-molded into bars including the first and second plastic bars, using a molding machine.

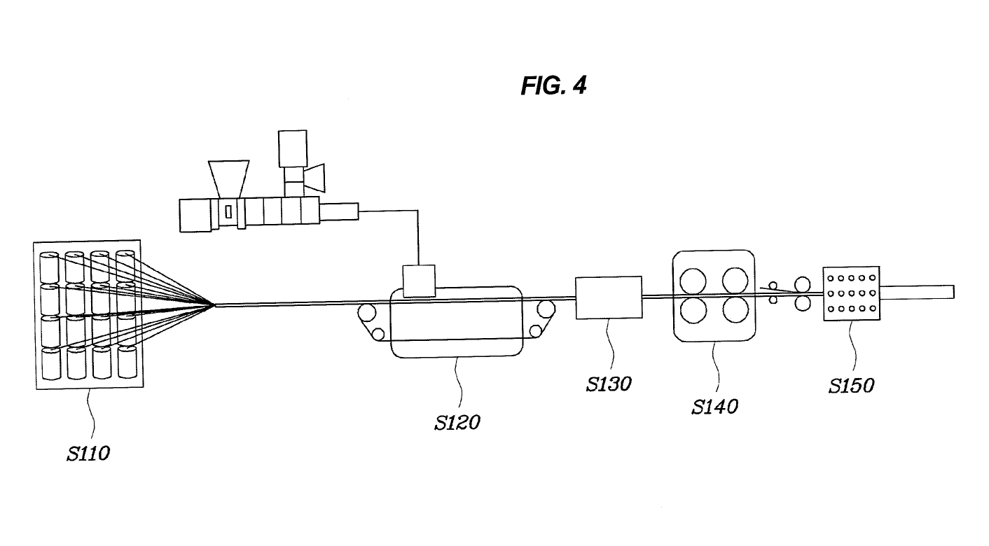

Specifically, referring to FIG. 4 showing a stage of forming a plastic bar in the manufacturing method, first a plurality of fiber strands is stacked together and stretched widely (S110), and the stretched fiber strands are impregnated with fused plastic resin, i.e. fused PP resin (S120). Then, the fiber strands impregnated with plastic resin are cooled so as to form a single film (S130), and the film is drawn by a puller (S140) to pass through a final forming unit so that a bar-type product is output (S150). Here, the bar-type product may be a rod product

The first and second plastic bars are all fabricated in the forming stage (S100), so that the fabricated bars can be divided into the first and second plastic bars depending upon whether the fabricated bar is used as the inner core 200 or the core cover 100.

In the meantime, after the forming stage (S100), a stage (S200) of preheating the first and second plastic bars to a predefined temperature is carried out. The preheating stage (S200) is a preparation stage that allows the first and second plastic bars, which were cured via cooling, to be formed into the inner core 200 and the core cover 100, respectively.

After the preheating stage (S200), a stage (S300) of forming the first plastic bars into a twisted shape, a stage (S400) of stacking the second plastic bars around the inner core 200, and a stage (S500) of forming the core cover by pressurizing the second plastic bars into a final shape using a press unit are carried out.

Here, the final shape may be a rod form that is generally curved like a bow in the longitudinal direction and whose axial section is circular.

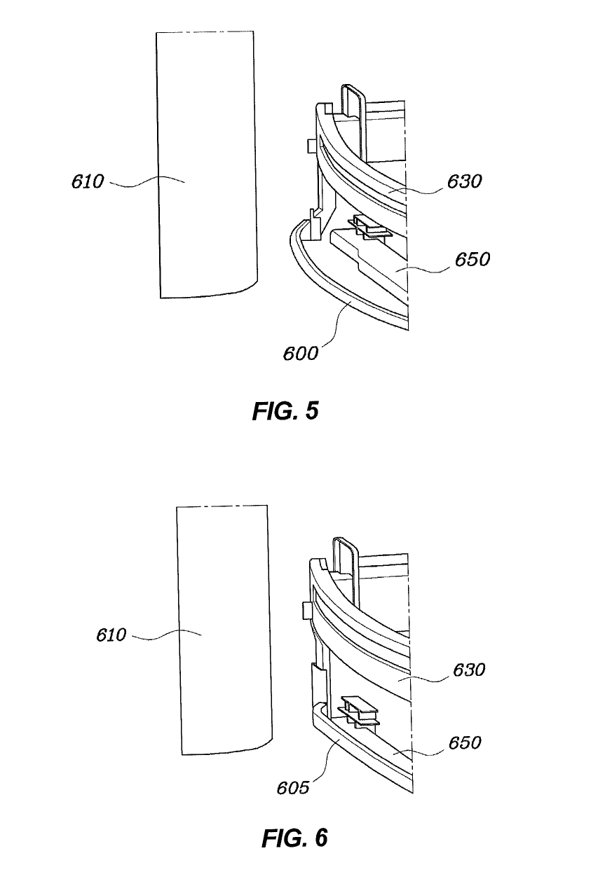

According to the above-mentioned configuration of the lower stiffener and the manufacturing method thereof, as shown in FIG. 5, the rod form of the lower stiffener 600 does not occupy much space in the lower portion of the bumper 630, and the bow like curved-shape allows a sufficient spacing to be maintained with respect to a frame 650 in a vehicle. Thus, even when the lower stiffener 600 is deformed in the event of a collision of a vehicle with an obstacle, it is difficult for the lower stiffener to come into contact with the frame 650, thereby considerably reducing the repairing cost upon a collision event.

Further, since the lower stiffener further protrudes compared to the bumper 630, upon a collision with a pedestrian, the lower stiffener primarily and sufficiently absorbs collision shock prior to the bumper 630, thereby lessening the pedestrian's collision shock.

FIG. 6 is a view showing a plate-type lower stiffener 605 for vehicles according to various embodiments of the present invention. As compared to the state of FIG. 5, it could be seen that, despite the fact that the lower stiffener occupies much more space near the lower portion of the bumper, the lower stiffener has little spacing with respect to the frame 650 of the vehicle.

In this case, upon a collision event, the lower stiffener 605 cannot be sufficiently deformed due to the existence of the frame 650, so the ability to absorbing collision shocks is considerably reduced. Further, since the lower stiffener is located inside the bumper 630, upon a collision event, the pedestrian first collides with the bumper 630, rather than the lower stiffener 605, so that the pedestrian's knees can be further damaged.

In the meantime, a collision test with respect to a pedestrian was carried out using the lower stiffener having the above-mentioned configuration, and the test results are as follows.

TABLE 1

| | Impact | Tibia | Bending | Shear |
|---|---|---|---|---|
| | Point | Acceleration | Angle | Displacement |
| No. | (mm) | (G) | (Deg) | (mm) |
| 1 | 0 | 128 | 5.9 | 0.7 |
| 2 | 100 | 120 | 6.8 | 0.64 |
| 3 | 200 | 117 | 5.93 | 0.7 |
| 4 | 300 | 108 | 5.4 | 0.87 |
| 5 | 450 | 132 | 4.63 | 1.23 |
| 6 | 480 | 133 | 5.22 | 1.4 |

Here, the impact point means a distance of the lower stiffener from the center thereof; wherein test No. 1 is the case where a pedestrian collides with the lower stiffener at the center position thereof, test No. 2 is the case where a pedestrian collides with the lower stiffener at a position separated laterally by 100 mm from the center position thereof, and tests Nos. 3 to 6 are the cases at various positions as indicated.

The tibia acceleration means acceleration of gravity that, when a pedestrian collides with the lower stiffener, is applied to the pedestrian's knees, wherein a proper value range thereof may be 150 G or less.

Further, the bending angle means an angle of the pedestrian's knee that is bent upon a collision event, wherein a proper value range thereof may be 150 degrees or less.

Finally, the shear displacement means a shear displacement of the pedestrian's knee, i.e., knee ligament, upon a collision event, wherein a proper value range thereof may be 5 mm or less.

Referring to Table 1, it could be seen that the tests Nos. 1 to 6, which were performed at different positions, all satisfy the proper value ranges for respective four factors. That is, although the test result values shown in Table 1 were the maximum values for respective factors, all of the test result values lie below the reference values, showing excellent effects. From this, it could be seen that the lower stiffener of the present invention sufficiently satisfies target performance.

According to the lower stiffener for vehicles having the above-mentioned configuration and the manufacturing method thereof, the lower stiffener made of plastic composite material has improved elasticity along with improved strength, effectively absorbing collision shocks upon collision with a pedestrian.

Further, the use of the plastic material contributes to a reduction in weight, compared to an existing steel-type product, to an adjustment in a shock absorption rate by means of adjustment of composition ratio between plastic and other material, and to an increase in degree of freedom in shaping of parts compared to as steel-type product, which increases availability of diversified designs for a bumper.

Furthermore, the mount is formed on the bar member not separately but integrally, thereby avoiding additional cost expenditure for the provision of the mount, and easily changing the shape of the mount.

For convenience in explanation and accurate definition in the appended claims, the terms lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A lower stiffener for a vehicle comprising:
a core cover longitudinally mounted along a lower portion of a bumper; and
an inner core longitudinally installed inside the core cover, wherein density and strength of the inner core are larger than those of the core cover.

2. The lower stiffener according to claim 1, further comprising a mount integrally provided on the core cover to connect the core cover to a vehicle frame.

3. The lower stiffener according to claim 1, wherein the core cover and the inner core are integrally formed with a plastic composite material.

4. The lower stiffener according to claim 1, wherein the inner core twists along the entire length thereof, and the core cover surrounds the inner core.

5. The lower stiffener according to claim 2, further comprising a reinforcing rib to connect the core cover and the mount.

6. The lower stiffener according to claim 3, wherein the plastic composite material is a continuous fiber reinforced thermoplastic plastic.

7. The lower stiffener according to claim 5, wherein the mount and the reinforcing rib are formed of a glass fiber reinforced composite material.

8. A method of manufacturing a lower stiffener for a vehicle, comprising:
forming a twisted inner core using a first plastic composite material; and
integrally forming a core cover over the inner core by placing a second plastic composite material around the inner core, and pressurizing the second plastic composite material.

9. The method according to claim 8, wherein the inner core is formed by twisting a plurality of first-plastic bars each being made of the first plastic composite material.

10. The method according to claim 8, wherein the core cover is formed by stacking a plurality of second-plastic bars, each being made of the second plastic composite material, around the inner core and pressurizing the stacked second-plastic bars.

11. The method according to claim 8, further comprising preheating the first and second plastic bars to a predefined temperature prior to the formation of the inner core.

12. The method according to claim 11, wherein the first and second plastic bars are formed prior to the preheating stage by impregnating a plurality of stretched fiber strands with fused plastic resin and injection-molding the former material into bars using a molding machine.
